(19) United States
(12) Patent Application Publication
(10) Pub. No.: US 2014/0086065 A1
(43) Pub. Date: Mar. 27, 2014

(54) DISJOINT MULTI-PATHS WITH SERVICE GUARANTEE EXTENSION

(71) Applicant: INTERNATIONAL BUSINESS MACHINES CORPORATION, (US)

(72) Inventors: Casimer M. DeCusatis, Poughkeepsie, NY (US); Keshav G. Kamble, Fremont, CA (US); Abhijit P. Kumbhare, San Jose, CA (US); Simarbir Singh, Plano, TX (US)

(73) Assignee: INTERNATIONAL BUSINESS MACHINES CORPORATION, Armonk, NY (US)

(21) Appl. No.: 13/625,703

(22) Filed: Sep. 24, 2012

(51) Int. Cl. H04L 12/26

(52) U.S. Cl. 370/242

(57) ABSTRACT

In one embodiment, a system includes a network manager including logic configured for determining at least one pair of disjoint paths between an ingress node and an egress node from the plurality of nodes in the network, each disjoint path having an ingress node, an egress node, and a number of nodes and connecting links therebetween, wherein each pair of disjoint paths shares no common nodes or links except for the ingress node and the egress node, and logic configured for determining characteristics of each of the at least one pair of disjoint paths based on an assigned cost of each link in the at least one pair of disjoint paths. In other embodiments, methods are described for providing disjoint multi-paths in a network.

### BACKGROUND

The present invention relates to data center infrastructure, and more particularly, this invention relates to utilizing disjoint multi-paths in a network with service guarantee.

All data center fabrics (networking, storage, and clustering) support multiple redundant paths through the network to provide for high availability of critical applications. In particular, storage traffic, e.g., Fibre Channel (FC), internet small computer system interface (iSCSI), FC over Ethernet (FCoE), etc., have traditionally used this approach to insure continuous availability of all the storage resources in a data center. Similar requirements may be found in traditional Ethernet networks or server clusters, e.g., remote direct memory access (RDMA) over converged Ethernet (RoCE), internet wide area RDMA protocol (iWARP), and/or similar RDMA protocols. This requirement may be achieved by implementing more than one physically separate network, with redundant switches and links.

A significant disadvantage of this approach is the administrative overhead associated with configuring, managing, and maintaining two separate networks. This may be overcome if a single network fabric is implemented which supports multi-pathing. Such fabrics utilize an alternative to spanning tree protocol (STP), which force a single path through the network and thus under-utilize network bandwidth (in the case of bridged domains, STP forces a single multi-cast tree to be available).

There are different types of multi-pathing, depending on whether the multiple paths through the network share common network devices or whether they are completely disjoint from each other. The highest levels of availability are provided by fabrics which support disjoint multi-pathing, preferably in a flat fabric which facilitates virtual machine (VM) migration in highly virtualized data centers.

There are several possible approaches to support disjoint multi-pathing using open, industry standard protocols, all of which have drawbacks. Accordingly, it would be beneficial to be able to implement disjoint multi-pathing which overcomes drawbacks of conventional methods.

### SUMMARY

In one embodiment, a system includes a network manager including logic configured for determining at least one pair of disjoint paths between an ingress node and an egress node from the plurality of nodes in the network, each disjoint path having an ingress node, an egress node, and a number of nodes and connecting links therebetween, wherein each pair of disjoint paths shares no common nodes or links except for the ingress node and the egress node, and logic configured for determining characteristics of each of the at least one pair of disjoint paths based on an assigned cost of each link in the at least one pair of disjoint paths.

In another embodiment, a computer program product for providing disjoint multi-paths in a network includes a computer readable storage medium having computer readable program code embodied therewith, the computer readable program code including computer readable program code configured for determining at least one pair of disjoint paths between an ingress node and an egress node from a plurality of nodes in a network, each disjoint path having an ingress node, an egress node, and a number of nodes and connecting links therebetween, wherein each pair of disjoint paths shares no common nodes or links except for the ingress node and the egress node, and computer readable program code configured for determining characteristics of each of the at least one pair of disjoint paths based on an assigned cost of each link in the at least one pair of disjoint paths.

According to yet another embodiment, a method for providing disjoint multi-paths in a network includes determining a graph algorithm that represents a network having a plurality of nodes and a plurality of links connecting each of the plurality of nodes, assigning a cost to each link from the plurality of links, determining at least one pair of disjoint paths between an ingress node and an egress node from the plurality of nodes, each disjoint path having the ingress node, the egress node, and a number of nodes and connecting links therebetween, wherein each pair of disjoint paths shares no common nodes or links except for the ingress node and the egress node, and determining characteristics of each of the at least one pair of disjoint paths based on the assigned cost of each link in the at least one pair of disjoint paths.

In another embodiment, a method for providing disjoint multi-paths in a network includes determining at least one pair of disjoint paths between an ingress node and an egress node from a plurality of nodes in a network, each disjoint path having the ingress node, the egress node, and a number of nodes and connecting links therebetween, wherein each pair of disjoint paths shares no common nodes or links except for the ingress node and the egress node, and determining characteristics of each of the at least one pair of disjoint paths based on an assigned cost of each link in the at least one pair of disjoint paths.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 is a simplified diagram of a network, according to one embodiment.

FIG. 4 is a simplified diagram of a network, according to one embodiment.

FIG. 5 is a flowchart of a method, according to one embodiment.

FIG. 6 is a flowchart of a method, according to another embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified.

In one general embodiment, a system includes a network manager including logic configured for determining at least one pair of disjoint paths between an ingress node and an egress node from the plurality of nodes in the network, each disjoint path having an ingress node, an egress node, and a number of nodes and connecting links therebetween, wherein each pair of disjoint paths shares no common nodes or links except for the ingress node and the egress node, and logic configured for determining characteristics of each of the at least one pair of disjoint paths based on an assigned cost of each link in the at least one pair of disjoint paths.

In another general embodiment, a computer program product for providing disjoint multi-paths in a network includes a computer readable storage medium having computer readable program code embodied therewith, the computer readable program code including computer readable program code configured for determining at least one pair of disjoint paths between an ingress node and an egress node from a plurality of nodes in a network, each disjoint path having an ingress node, an egress node, and a number of nodes and connecting links therebetween, wherein each pair of disjoint paths shares no common nodes or links except for the ingress node and the egress node, and computer readable program code configured for determining characteristics of each of the at least one pair of disjoint paths based on an assigned cost of each link in the at least one pair of disjoint paths.

According to yet another general embodiment, a method for providing disjoint multi-paths in a network includes determining a graph algorithm that represents a network having a plurality of nodes and a plurality of links connecting each of the plurality of nodes, assigning a cost to each link from the plurality of links, determining at least one pair of disjoint paths between an ingress node and an egress node from the plurality of nodes, each disjoint path having the ingress node, the egress node, and a number of nodes and connecting links therebetween, wherein each pair of disjoint paths shares no common nodes or links except for the ingress node and the egress node, and determining characteristics of each of the at least one pair of disjoint paths based on the assigned cost of each link in the at least one pair of disjoint paths.

In another general embodiment, a method for providing disjoint multi-paths in a network includes determining at least one pair of disjoint paths between an ingress node and an egress node from a plurality of nodes in a network, each disjoint path having the ingress node, the egress node, and a number of nodes and connecting links therebetween, wherein each pair of disjoint paths shares no common nodes or links except for the ingress node and the egress node, and determining characteristics of each of the at least one pair of disjoint paths based on an assigned cost of each link in the at least one pair of disjoint paths.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium include the following: a portable computer diskette, a hard disk, a random access memory (RAM), a read-only memory (ROM), an erasable programmable read-only memory (EPROM or Flash memory), a portable compact disc read-only memory (CD-ROM), a Blu-ray disc read-only memory (BD-ROM), an optical storage device, a magnetic storage device, or any suitable combination of the foregoing. In the context of this document, a non-transitory computer readable storage medium may be any tangible medium that is capable of containing, or storing a program or application for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device, such as an electrical connection having one or more wires, an optical fibre, etc.

Program code embodied on a computer readable medium may be transmitted using any appropriate medium, including but not limited to wireless, wireline, optical fibre cable, RF, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN), storage area network (SAN), and/or a wide area network (WAN), or the connection may be made to an external computer, for example through the Internet using an Internet Service Provider (ISP).

Aspects of the present invention are described herein with reference to flowchart illustrations and/or block diagrams of methods, apparatuses (systems), and computer program products according to various embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

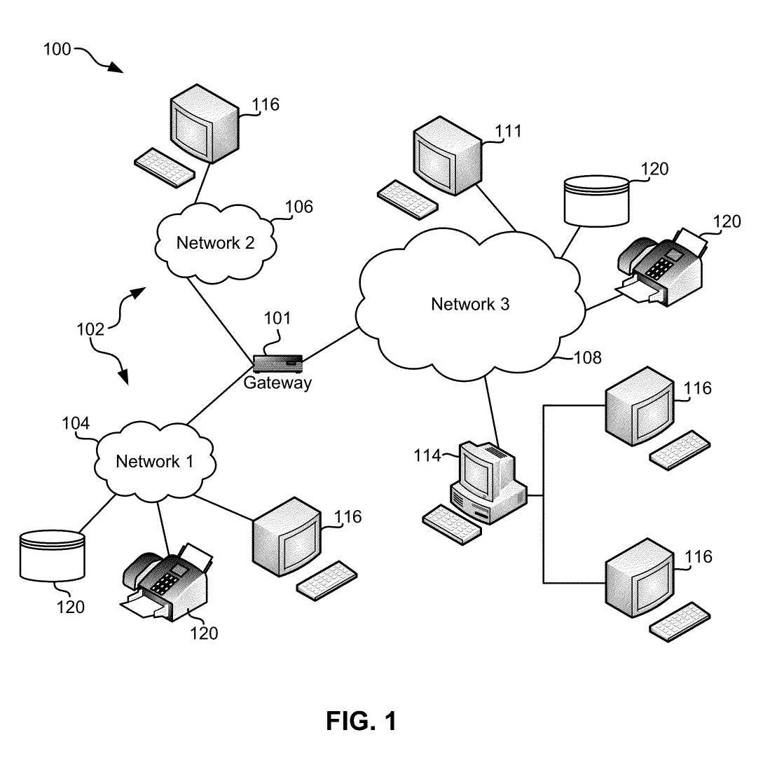

FIG. 1 illustrates a network architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, handheld computer, printer, and/or any other type of logic-containing device. It should be noted that a user device 111 may also be directly coupled to any of the networks, in some embodiments.

A peripheral 120 or series of peripherals 120, e.g., facsimile machines, printers, scanners, hard disk drives, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used, as known in the art.

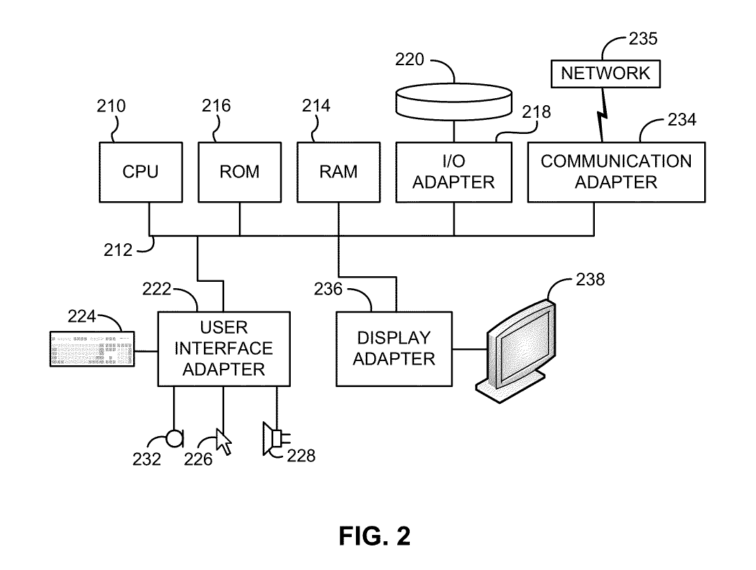

FIG. 2 shows a representative hardware environment associated with a user device 116 and/or server 114 of FIG. 1, in accordance with one embodiment. FIG. 2 illustrates a typical hardware configuration of a workstation having a central processing unit (CPU) 210, such as a microprocessor, and a number of other units interconnected via one or more buses 212 which may be of different types, such as a local bus, a parallel bus, a serial bus, etc., according to several embodiments.

The workstation shown in FIG. 2 includes a Random Access Memory (RAM) 214, Read Only Memory (ROM) 216, an I/O adapter 218 for connecting peripheral devices such as disk storage units 220 to the one or more buses 212, a user interface adapter 222 for connecting a keyboard 224, a mouse 226, a speaker 228, a microphone 232, and/or other user interface devices such as a touch screen, a digital camera (not shown), etc., to the one or more buses 212, communication adapter 234 for connecting the workstation to a communication network 235 (e.g., a data processing network) and a display adapter 236 for connecting the one or more buses 212 to a display device 238.

The workstation may have resident thereon an operating system such as the MICROSOFT WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

According to various embodiments described herein, a routing algorithm implemented in a network may include the following characteristics: optimality, simplicity and low overhead, stability and robustness, scalability, convergence, and flexibility.

Optimality of the algorithm may be defined as the ability of the algorithm to employ the best route from among a set of available routes between a source and a destination. The metrics employed influence the optimality of the algorithm. Achieving optimality is easy with a static network but becomes an issue of concern in a dynamic network.

Simplicity is a desirable criterion in the design of a routing algorithm. The routing algorithm should offer its functionality efficiently, with a minimum of software and utilization overhead. Simplicity is particularly important when the software implementing the routing algorithm runs on a computer with limited physical resources.

Robustness describes an ability of the algorithm to be resistant to failures. Robust algorithms may change routes in case of link failures and/or node failures. The current best routing algorithms are often those that have withstood the test of time and that have proven stable under a variety of network conditions.

Scalability may be defined as an ability to increase the number of participants in the network without a concomitant increase in routing overhead. This is one reason for making the routing model of the internet to be a multi-layered hierarchical one, rather than a flat one.

Convergence is the process of agreement, by all routers, on optimal routes. In transient network conditions routes may become unavailable, and hence routers may distribute routing update messages that permeate networks, stimulating recalculation of optimal routes, and eventually causing all routers to agree on these routes. Routing algorithms that converge slowly may result in routing loops or network outages.

Flexibility of the algorithm implies the ability of the algorithm to adapt to changes in the network. Routing algorithms may be programmed to adapt to changes in network bandwidth, router queue size, and network delay, among other variables.

Routing algorithms may also be classified on the basis of desirable outputs expected from the algorithms. Some of the desired outputs are described below.

Achieving loop free paths is highly desirable in routing, as a looped path may indefinitely cause packets to keep circulating within the network without reaching a destination, resulting in bandwidth wastage and processing overhead at the various intermediate nodes.

Achieving disjoint multiple paths from source to destination can lead to effective usage of the network resources and also enable load balancing between disjoint multiple paths.

Given a connected graph (network), a routing algorithm should find at least one path from any source to every other destination in the network. In one sense, reachability may imply achieving all possible paths and in another sense it may just mean to guarantee that there exists a path from every source to every other destination.

Achieving disjoint multiple paths according to the network properties such as individual paths for low latency, converged enhanced Ethernet (CEE) reliability, quality of service, media type, etc. A routing algorithm may provide disjoint paths that meet the specific network properties useful for each high level application.

With the continuing growth and dynamism of large-scale networks, the need for alternate algorithms is becoming increasingly important. The emergence complex network requirements calls for algorithms that are capable of distributing data traffic across multiple paths and at the same time filter the disjoint paths according to the network requirements.

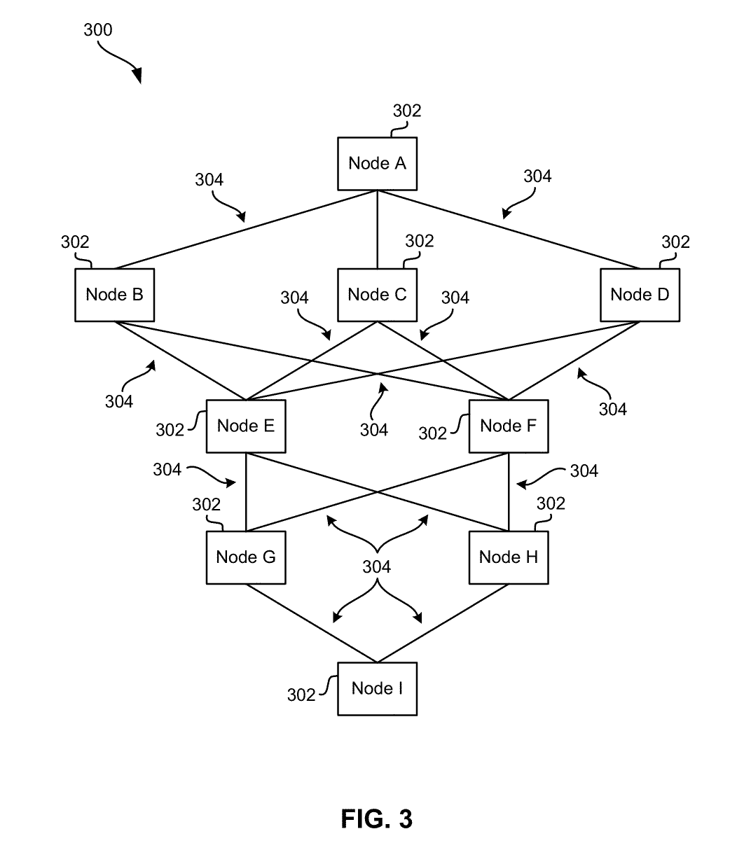

Accordingly, in one embodiment shown in FIG. 3, a computer network 300 may be visualized as a graph. In this embodiment, the computer network 300 is represented as a graph G=(N, L) where N is a set of nodes 302 (such as routers, switches, etc.) and L is a set of edges 304 (links) connecting the nodes 302. As would be understood by one of skill in the art, network 300 is merely an exemplary network that is simplified for representation. Real world installations would necessitate vastly larger networks utilizing many more nodes and links, and much more complexity overall, including different node types, different link types, etc.

According to one embodiment, a cost is associated with each link L and may change over time (as network conditions change), but is always a positive integer. Events which may change a link's cost includes, but is not limited to, changes in network layout, changes to link type, changes to node availability, addition/subtraction of network components, etc.

Two nodes N connected by a link L are referred to as adjacent nodes or neighbors. Some examples of adjacent nodes are Nodes B and E or Nodes A and D which are connected by a link, as shown in FIG. 3.

The set of all neighbors of a given node, i, is denoted by Ni. For example, as shown in FIG. 3, Node E has a set of neighbors that consists of Node B, Node C, Node H, and Node G. Adjacent nodes communicate with each other using messages and messages transmitted over an operational link are received with no errors, in the proper sequence, and within a finite time, due to the nature of these types of messages. Furthermore, such messages are processed by the receiving node one at a time in the order received. Each node N is capable of detecting the failure, recovering and linking cost changes of each adjacent link within a finite time.

Now, a basic algorithm for graph theory representation of a network is described according to one embodiment. This algorithm takes into account using disjoint multi-paths through the network. For a network 300 that is represented by a directed graph, G=(V, E), where V is a set of vertices (nodes) 302 and E is a set of edges (links) 304, each link (u, v) may be represented by two nonnegative measures, according to one embodiment, namely: a delay δ(u, v) and a residual bandwidth R(u, v).

When the disjoint paths are determined, one of the edge nodes, e.g., Node B, Node G, Node D, Node F, etc., will determine path(s) based on characteristics provided by a server. These characteristics may be properties desired by someone who programmed the server, such as a network administrator, or they may be properties inherent to particular traffic types, such as SAN traffic (which requires paths with the best reliability), voice traffic (which requires the best link quality of service), etc.

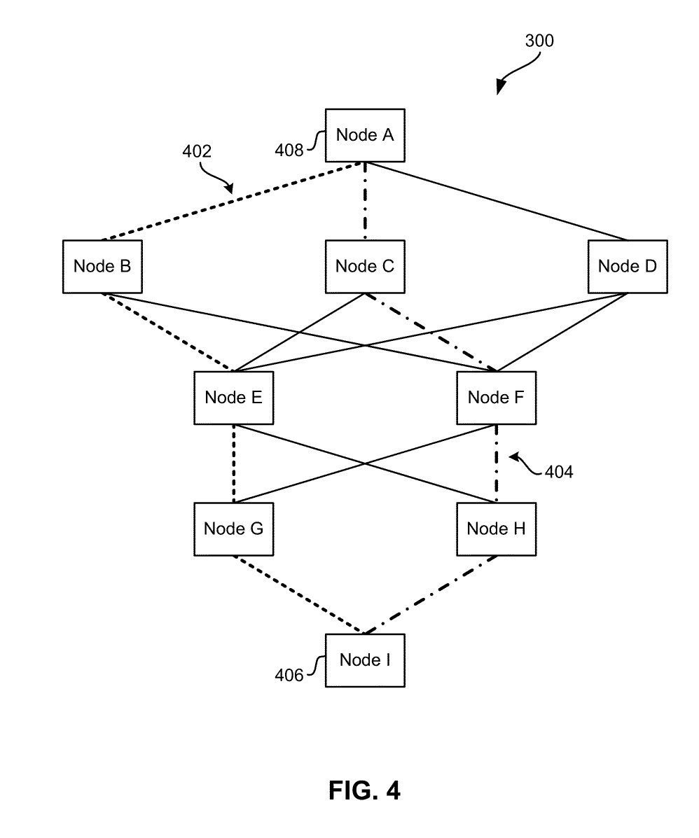

Now referring to FIG. 4, given a source node s, for this example the source node is Node I 406 and a destination node d, for this example the destination node is Node A 408, the algorithm enables a pair of disjoint paths, namely p′ 402 and p″ 404, to be determined such that p′ 402 and p″ 404 do not share any common nodes between them (except for the source node s and destination node d). Disjoint paths p′ 402 and p″ 404 are indicated in FIG. 4 using broken lines. Disjoint path p′ 402 is represented as I→G→E→B→A, while disjoint path p″ 404 is represented as I→H→F→C→A.

If such a pair of disjoint paths exists, then this pair of paths includes two feasible paths, which are included in a set of feasible paths, from which a number of disjoint multi-paths may be selected.

It is noted that there are several different sets of disjoint multi-paths available, even for the relatively simple network 300 represented in FIGS. 3-4. For example, disjoint path p″ 404 may utilize Node D instead of Node C, such that the path is I→H→F→D→A. In another example, disjoint path p′ 402 may use Node F instead of Node E such that the path is I→G→F→B→A, and then disjoint path p″ 404 may use Node E instead of Node F such that the path is I→H→E→C→A, and this would produce another set of disjoint paths. Accordingly, many different disjoint multi-paths are generally possible through any network, particularly complex networks that exist in real world installations.

Multi-path routing presents several advantages over single-path routing. First, a multi-path routing protocol is capable of meeting multiple performance objectives—maximizing throughput, minimizing delay, bounding delay variation, minimizing packet loss, or any other desired performance objective. Second, from a scalability perspective, multi-path routing makes effective use of the graph structure of a network (as opposed to single-path routing which superimposes a logical routing tree upon the network topology). Third, multi-path routing protocols are more tolerant of network failures. In addition, multi-path routing algorithms are less susceptible to route oscillations, which enables the use of high-variance cost metrics that are better congestion indicators, whereas current single-path routing algorithms face route oscillations since they switch routes as a step function.

According to one embodiment, a disjoint multi-pathing algorithm may be provided with service extension. Having said that, while disjoint multi-pathing is desirable, it is often useful to filter down the paths according to network requirements, as they may be stipulated by a network administrator or discovered by the routing algorithm. According to one embodiment, changes in the current algorithm may be made and further enhanced disjoint multi-pathing may be determined to give the best paths which meet the new requirements.

Algorithms, as described herein, aim to deliver a disjoint network manager which would consider the nature of the network paths while calculating all the disjoint paths between two nodes. The paths found this way provide the exact type of service required for the end application. Since, the fabric is a set of shared networking resources, there will be different disjoint paths for different types of end applications. The network requirements may be set according to any desired criteria, such as: Low Link Latency sensitive, Link Reliability service, Link Quality of Service, Link Media Type, Energy Efficient Ethernet (EEE), synchronous Ethernet capability, etc. Each of these criterion are described in more detail below.

Link Latency sensitive Network Path would provide paths with all equal minimal link latencies. This type of configuration is especially useful for high frequency type (HFT) applications. Each link along the path collects its own latency integer. For calculating the link latency, the intermediate switches may use IEEE 1588 (“Standard for A Precision Clock Synchronization Protocol for Networked Measurement and Control Systems”) dictated by the National Institute of Standards and Technology (NIST) or Precision Time Protocol (PTP), either version 1 or version 2. This latency number may be used as an attribute of the link that may be used while finding disjoint paths.

Link Reliability as Network Path Requirement may be achieved by using CEE which recommends use of 802.1Qbb or Priority-Based Flow Control (PFC) to make the link more reliable. This reliability is useful for all types of I/O bound networks, such as Fiber Channel over Ethernet (FCoE). With this option as an extension to the algorithm, multiple disjoint paths which support CEE end to end may be determined.

Link Quality of Service as Network Path Requirement may be visualized per hop and end to end to provide reliability, particularly to voice and video sensitive applications. For such applications, this extension to the algorithm may provide multiple disjoint paths which satisfy reliability metrics.

Link Media Type may provide disjoint multi-paths which utilize specific types of media. Network port links may comprise optical media, copper media, or some other media type. Amongst these types, there are multiple subtypes based on short range, medium range, long range, etc., which are designed for specific installations. These types of media connectors have different properties in terms of latency, reliability over the distance, cost, etc. For example, copper media adds a significant amount of latency compared to optical media. Certain applications, e.g., FCoE for use in storage applications, does not prefer transmissions over copper ports due to latency and reliability issues associated with copper ports. With the extension to the disjoint multi-path algorithm, network media type is considered as a property of the link while determining disjoint paths from one point to another.

Energy Efficient Ethernet provides various ways of saving power on a port to port basis. As the link activity slows or has an idle period, some parts of the port stops receiving clocks thereby saving power. Though there are no applications which mandate use of EEE, this extension to the disjoint multi-path algorithm provides options to discover multiple disjoint energy efficient paths through the complex network.

Synchronous Ethernet capability describes a path's ability to handle real-time applications, which is useful in applications such as hazardous situation monitoring, airline guidance/directing, reactor control, and other real time applications.

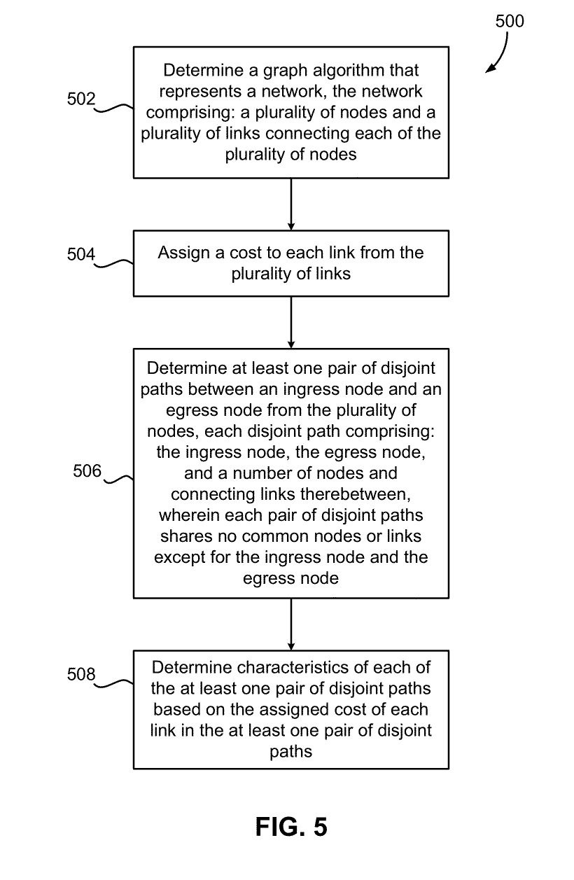

Now referring to FIG. 5, a flowchart of a method 500 for providing disjoint multi-paths in a network is shown, according to one embodiment. The method 500 may be performed in accordance with the present invention in any of the environments depicted in FIGS. 1-4, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in one embodiment, the method 500 may be partially or entirely performed by a control plane of a network, the control plane being adapted for providing control functionality to all of the nodes in a network.

As shown in FIG. 5, method 500 may initiate with operation 502, where a graph algorithm that represents a network is determined. The network comprises a plurality of nodes and a plurality of links connecting each of the plurality of nodes.

In operation 504, a cost is assigned to each link from the plurality of links.

According to one embodiment, the cost assigned to each link in the network may be determined based on one of a plurality of characteristics inherent to each link. For example, the plurality of characteristics inherent to each link may comprise a latency of the link, a reliability of the link, a quality of service of the link, a media type of the link, and an energy efficiency of the link, an ability of the link to perform synchronously, etc.

In operation 506, at least one pair of disjoint paths are determined between an ingress node and an egress node from the plurality of nodes. Each disjoint path comprises the ingress node, the egress node, and a number of nodes and connecting links therebetween. Each pair of disjoint paths shares no common nodes or links except for the ingress node and the egress node, as is commonly understood by one of skill in the art.

The pairs of disjoint paths may be determined using any method known in the art, and may take into account that multiple disjoint paths ay utilize the same links and/or nodes, as long as the pair path does not utilize the same links and/or nodes.

In operation 508, characteristics of each of the at least one pair of disjoint paths are determined based on the assigned cost of each link in the at least one pair of disjoint paths. The link characteristics may include any of the following: low link latency, high link reliability, high link quality of service, a desired type of media, a highly efficient link, synchronous link capability, etc.

In a further embodiment, the method 500 may include receiving a desired link characteristic, filtering the at least one pair of disjoint paths in order to choose one pair of disjoint paths that is most capable of providing the desired link characteristic, and designating the one pair of disjoint paths as having the desired link characteristic.

According to another embodiment, the desired link characteristic may be chosen from a group including low link latency, high link reliability, high link quality of service, a desired type of media, a highly efficient link, synchronous link capability, etc.

Furthermore, in some approaches, information relating to the designated one pair of disjoint paths may be sent to each node in the one pair of disjoint paths such that each node in the one pair of disjoint paths forwards traffic to a next node in the one pair of disjoint paths according to the designated one pair of disjoint paths. The information may include a forwarding address of a next node to send traffic to, forwarding information for the entire disjoint path, an action to take upon receiving information from a particular node, etc.

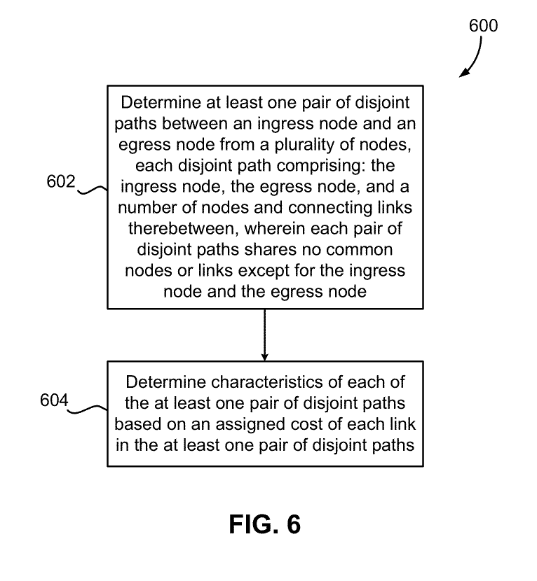

Now referring to FIG. 6, a flowchart of a method 600 for providing disjoint multi-paths in a network is shown, according to one embodiment. The method 600 may be performed in accordance with the present invention in any of the environments depicted in FIGS. 1-4, among others, in various embodiments. Of course, more or less operations than those specifically described in FIG. 6 may be included in method 600, as would be understood by one of skill in the art upon reading the present descriptions.

Each of the steps of the method 600 may be performed by any suitable component of the operating environment. For example, in one embodiment, the method 600 may be partially or entirely performed by a control plane of a network, the control plane being adapted for providing control functionality to all of the nodes in a network.

As shown in FIG. 6, method 600 may initiate with operation 602, where at least one pair of disjoint paths are determined between an ingress node and an egress node from a plurality of nodes in a network. Each disjoint path comprises an ingress node, an egress node, and a number of nodes and connecting links therebetween. Each pair of disjoint paths shares no common nodes or links except for the ingress node and the egress node.

In operation 604, characteristics of each of the at least one pair of disjoint paths are determined based on an assigned cost of each link in the at least one pair of disjoint paths. The cost assigned to each link in the network is determined based on one of a plurality of characteristics inherent to each link. The plurality of characteristics inherent to each link may be chosen from among any of the following: a latency of the link, a reliability of the link, a quality of service of the link, a media type of the link, and an energy efficiency of the link, among other possibilities.

According to a further embodiment, the method 600 may include receiving a desired link characteristic, choosing one pair of disjoint paths from the at least one pair of disjoint paths that is most capable of providing the desired link characteristic, and designating the one pair of disjoint paths to each node in the one pair of disjoint paths such that each node in the one pair of disjoint paths forwards traffic to a next node in the one pair of disjoint paths.

In another further embodiment, the method 600 may include determining a desired link characteristic based on a type of network traffic, choosing one pair of disjoint paths from the at least one pair of disjoint paths that is most capable of providing the desired link characteristic, and designating the one pair of disjoint paths. Furthermore, the method 600 may also include sending information relating to the designated one pair of disjoint paths to each node in the one pair of disjoint paths such that each node in the one pair of disjoint paths forwards traffic to a next node in the one pair of disjoint paths according to the designated one pair of disjoint paths. The desired link characteristic may be chosen from a group including: low link latency, high link reliability, high link quality of service, a desired type of media, a highly efficient link, and/or synchronous link capability.

In more embodiments, referring again to FIGS. 5-6, any or all operations of either method 500 or method 600 may be implemented in a system or a computer program product.

For example, in one embodiment, a system may comprise a network having a plurality of nodes and a plurality of links connecting the plurality of nodes, a network manager having logic configured for determining at least one pair of disjoint paths between an ingress node and an egress node from the plurality of nodes in the network, each disjoint path comprising an ingress node, an egress node, and a number of nodes and connecting links therebetween. Each pair of disjoint paths shares no common nodes or links except for the ingress node and the egress node. The system also includes logic configured for determining characteristics of each of the at least one pair of disjoint paths based on an assigned cost of each link in the at least one pair of disjoint paths.

In another example, a computer program product for providing disjoint multi-paths in a network comprises a computer readable storage medium having computer readable program code embodied therewith. The computer readable program code includes computer readable program code configured for determining at least one pair of disjoint paths between an ingress node and an egress node from a plurality of nodes in a network, each disjoint path comprising an ingress node, an egress node, and a number of nodes and connecting links therebetween, wherein each pair of disjoint paths shares no common nodes or links except for the ingress node and the egress node, and computer readable program code configured for determining characteristics of each of the at least one pair of disjoint paths based on an assigned cost of each link in the at least one pair of disjoint paths.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A system, comprising:
a network manager, comprising:
logic configured for determining at least one pair of disjoint paths between an ingress node and an egress node from the plurality of nodes in the network, each disjoint path comprising:
an ingress node;
an egress node; and
a number of nodes and connecting links therebetween,
wherein each pair of disjoint paths shares no common nodes or links except for the ingress node and the egress node; and
logic configured for determining characteristics of each of the at least one pair of disjoint paths based on an assigned cost of each link in the at least one pair of disjoint paths.

2. The system as recited in claim 1, wherein the cost assigned to each link in a network is determined based on one of a plurality of characteristics inherent to each link.

3. The system as recited in claim 2, wherein the plurality of characteristics inherent to each link comprises:
a latency of the link;
a reliability of the link;
a quality of service of the link;
a media type of the link; and
an energy efficiency of the link.

4. The system as recited in claim 1, further comprising:
logic configured for receiving a desired link characteristic;
logic configured for choosing one pair of disjoint paths from the at least one pair of disjoint paths that is most capable of providing the desired link characteristic; and
logic configured for designating the one pair of disjoint paths to each node in the one pair of disjoint paths such that each node in the one pair of disjoint paths forwards traffic to a next node in the one pair of disjoint paths.

5. The system as recited in claim 1, further comprising:
logic configured for determining a desired link characteristic based on a type of network traffic;
logic configured for filtering the at least one pair of disjoint paths in order to choose one pair of disjoint paths that is most capable of providing the desired link characteristic; and
logic configured for designating the one pair of disjoint paths as having the desired link characteristic.

6. The system as recited in claim 5, wherein the desired link characteristic is chosen from a group consisting of:
low link latency;
high link reliability;
high link quality of service;
a desired type of media;
a highly efficient link; and
synchronous link capability.

7. The system as recited in claim 5, further comprising logic configured for sending information relating to the designated one pair of disjoint paths to each node in the one pair of disjoint paths such that each node in the one pair of disjoint paths forwards traffic to a next node in the one pair of disjoint paths according to the designated one pair of disjoint paths.

8. A computer program product for providing disjoint multi-paths in a network, the computer program product comprising a computer readable storage medium having computer readable program code embodied therewith, the computer readable program code comprising:
computer readable program code configured for determining at least one pair of disjoint paths between an ingress node and an egress node from a plurality of nodes in a network, each disjoint path comprising:
an ingress node;
an egress node; and
a number of nodes and connecting links therebetween,
wherein each pair of disjoint paths shares no common nodes or links except for the ingress node and the egress node; and
computer readable program code configured for determining characteristics of each of the at least one pair of disjoint paths based on an assigned cost of each link in the at least one pair of disjoint paths.

9. The computer program product as recited in claim 8, wherein the cost assigned to each link in the network is determined based on one of a plurality of characteristics inherent to each link.

10. The computer program product as recited in claim 9, wherein the plurality of characteristics inherent to each link comprises:
a latency of the link;
a reliability of the link;
a quality of service of the link;
a media type of the link; and
an energy efficiency of the link.

11. The computer program product as recited in claim 8, further comprising:
computer readable program code configured for receiving a desired link characteristic;
computer readable program code configured for choosing one pair of disjoint paths from the at least one pair of disjoint paths that is most capable of providing the desired link characteristic; and
computer readable program code configured for designating the one pair of disjoint paths to each node in the one pair of disjoint paths such that each node in the one pair of disjoint paths forwards traffic to a next node in the one pair of disjoint paths.

12. The computer program product as recited in claim 8, further comprising:
computer readable program code configured for determining a desired link characteristic based on a type of network traffic;
computer readable program code configured for filtering the at least one pair of disjoint paths in order to choose one pair of disjoint paths that is most capable of providing the desired link characteristic; and
computer readable program code configured for designating the one pair of disjoint paths as having the desired link characteristic.

13. The computer program product as recited in claim 12, wherein the desired link characteristic is chosen from a group consisting of:
low link latency;
high link reliability;
high link quality of service;
a desired type of media;
a highly efficient link; and
synchronous link capability.

14. The computer program product as recited in claim 12, further comprising computer readable program code configured for sending information relating to the designated one pair of disjoint paths to each node in the one pair of disjoint paths such that each node in the one pair of disjoint paths forwards traffic to a next node in the one pair of disjoint paths according to the designated one pair of disjoint paths.

15. A method for providing disjoint multi-paths in a network, the method comprising:
determining a graph algorithm that represents a network having a plurality of nodes and a plurality of links connecting each of the plurality of nodes;
assigning a cost to each link from the plurality of links;
determining at least one pair of disjoint paths between an ingress node and an egress node from the plurality of nodes, each disjoint path comprising:
the ingress node;
the egress node; and
a number of nodes and connecting links therebetween,
wherein each pair of disjoint paths shares no common nodes or links except for the ingress node and the egress node; and
determining characteristics of each of the at least one pair of disjoint paths based on the assigned cost of each link in the at least one pair of disjoint paths.

16. The method as recited in claim 15, wherein the cost assigned to each link in the network is determined based on one of a plurality of characteristics inherent to each link.

17. The method as recited in claim 16, wherein the plurality of characteristics inherent to each link comprises:
a latency of the link;
a reliability of the link;
a quality of service of the link;
a media type of the link; and
an energy efficiency of the link.

18. The method as recited in claim 15, further comprising:
receiving a desired link characteristic;
filtering the at least one pair of disjoint paths in order to choose one pair of disjoint paths that is most capable of providing the desired link characteristic; and
designating the one pair of disjoint paths as having the desired link characteristic.

19. The method as recited in claim 18, wherein the desired link characteristic is chosen from a group consisting of:
low link latency;
high link reliability;
high link quality of service;
a desired type of media;
a highly efficient link; and
synchronous link capability.

20. The method as recited in claim 18, further comprising sending information relating to the designated one pair of disjoint paths to each node in the one pair of disjoint paths such that each node in the one pair of disjoint paths forwards traffic to a next node in the one pair of disjoint paths according to the designated one pair of disjoint paths.

21. A method for providing disjoint multi-paths in a network, the method comprising:
determining at least one pair of disjoint paths between an ingress node and an egress node from a plurality of nodes in a network, each disjoint path comprising:
the ingress node;
the egress node; and
a number of nodes and connecting links therebetween,
wherein each pair of disjoint paths shares no common nodes or links except for the ingress node and the egress node; and
determining characteristics of each of the at least one pair of disjoint paths based on an assigned cost of each link in the at least one pair of disjoint paths.

22. The method as recited in claim 21, wherein the cost assigned to each link in the network is determined based on one of a plurality of characteristics inherent to each link, wherein the plurality of characteristics inherent to each link comprises:
a latency of the link;
a reliability of the link;
a quality of service of the link;
a media type of the link; and
an energy efficiency of the link.

23. The method as recited in claim 21, further comprising:
receiving a desired link characteristic;
choosing one pair of disjoint paths from the at least one pair of disjoint paths that is most capable of providing the desired link characteristic; and
designating the one pair of disjoint paths to each node in the one pair of disjoint paths such that each node in the one pair of disjoint paths forwards traffic to a next node in the one pair of disjoint paths.

24. The method as recited in claim 21, further comprising:
determining a desired link characteristic based on a type of network traffic;
choosing one pair of disjoint paths from the at least one pair of disjoint paths that is most capable of providing the desired link characteristic; and
designating the one pair of disjoint paths.

25. The method as recited in claim 24, further comprising sending information relating to the designated one pair of disjoint paths to each node in the one pair of disjoint paths such that each node in the one pair of disjoint paths forwards traffic to a next node in the one pair of disjoint paths according to the designated one pair of disjoint paths,
wherein the desired link characteristic is chosen from a group consisting of:
low link latency;
high link reliability;
high link quality of service;
a desired type of media;
a highly efficient link; and
synchronous link capability.
